(19) United States
(12) Patent Application Publication
(10) Pub. No.: US 2007/0077489 A1
(43) Pub. Date: Apr. 5, 2007

(54) POSITIVE ELECTRODE FOR AN ALKALINE BATTERY

(75) Inventor: Patrick Bernard, Bordeaux (FR)

Correspondence Address: SUGHRUE MION, PLLC, 2100 PENNSYLVANIA AVENUE, N.W., SUITE 800, WASHINGTON, DC, 20037, US

(73) Assignee: SAFT, Bagnolet (FR)

(21) Appl. No.: 11/470,775

(22) Filed: Sep. 7, 2006

(30) Foreign Application Priority Data
Sep. 9, 2005 (FR) 05 09 185

(51) Int. Cl. H01M 4/62; H01M 4/32

(52) U.S. Cl. 429/217; 429/232; 429/223

(57) ABSTRACT

A positive electrode for an alkaline electrolyte battery comprising a conductive support covered with a paste comprising: an electrochemically-active material, a binder and non-conductive fibres with a length comprised between 0.05 and 1 mm, the weight percentage of the fibres representing from 0.6 to 1.5% of the weight of said paste. An alkaline electrolyte battery comprising such an electrode.

### TECHNICAL FIELD

The present invention relates to a positive electrode (cathode) for an alkaline electrolyte battery, such as for example nickel-cadmium, nickel-iron, nickel-hydrogen and nickel metal hydride batteries. It also includes the battery containing such an electrode.

### STATE OF THE ART

Several types of electrodes exist which are capable of being used in an alkaline electrolyte battery, such as sintered electrodes and non-sintered electrodes, also called pasted or plasticized electrodes. Compared to the other types of electrodes, a non-sintered electrode contains a larger quantity of active material, its capacity is therefore increased and its production costs are reduced.

A non-sintered nickel electrode is composed of a conductive electrical support serving as a current collector, onto which a paste is deposited containing the electrochemically-active material based on nickel hydroxide Ni(OH)₂.

The conductive support can be three-dimensional and for example be constituted by a nickel foam. It can also be two-dimensional and in this case, it is generally constituted by a perforated metal foil or by an expanded metal foil. Once the paste is deposited on the support, the whole is compressed and dried in order to obtain an electrode of the desired density and thickness.

The production method for an electrode comprising a two-dimensional conductive support is simpler and less costly to implement than for an electrode comprising a three-dimensional support. This is why the use of a two-dimensional support is sometimes preferred to that of a three-dimensional conductor.

However the mechanical performance of the active material and its adhesion to the two-dimensional support are generally poor. In order to improve the mechanical performance and the adhesion of the active material to the two-dimensional support, several solutions have been proposed.

Document EP-A-0930663 proposes adding a binder which is a mixture of an elastomer and a crystalline polymer to the active material.

Document EP-A-1255313 proposes adding a binder which is a mixture of a butadiene copolymer and an ethylene and vinyl acetate copolymer to the active material.

Another solution, described in the document EP-A-0750358, consists of using a conductive support constituted by a corrugated metal plate on which teeth are formed. The surface of this corrugated plate is covered with a microscopically-irregular layer composed of nickel and/or cobalt powder bonded by a polyvinyl alcohol. A paste is deposited onto this coating comprising a binder which is a mixture of carboxymethyl cellulose CMC and a styrene/butadiene SBR copolymer.

Document WO-A-00/10212 describes a plasticized electrode comprising an active material based on nickel hydroxide, a binder, a conductive compound and a conductive material in the form of nickel fibres. The percentage of nickel fibres represents from approximately 0.1% to approximately 35% of the weight of the nickel hydroxide, preferably from approximately 2% to approximately 10% of the weight of the nickel hydroxide. It is specified that this electrode has high conductivity and high capacity.

The addition of a binder to the active material has the following drawbacks:

On the one hand, it has the effect of reducing the quantity of active material per electrode and therefore the capacity of the battery. In fact, the volume of paste which can be supported by the current collector being fixed, the presence of a binder requires a reduction in the quantity of the other constituents of the paste, such as for example the quantity of active material.

On the other hand, the binder is most often constituted by a polymer which tends to degrade as the battery is used. The polymer will produce a large quantity of carbonates, proportional to the quantity of polymer initially present in the battery. The applicant believes, without wishing to be bound by this theory, that the presence of carbonates impairs the electrical performance of the battery.

A nickel electrode is therefore sought for an alkaline electrolyte battery comprising a reduced quantity of binder compared to the electrodes of the prior art and of which the mechanical stability of the active material and the adhesion to the conductive support are at least equivalent to the electrodes of the prior art.

### SUMMARY OF THE INVENTION

For this purpose the invention proposes a positive electrode for an alkaline electrolyte battery comprising a conductive support covered with a paste comprising:
an electrochemically-active material,
a binder, and
non-conductive fibres with a length comprised between 0.05 and 1 mm, the weight percentage of the fibres representing from 0.6 to 1.5% of the weight of said paste.

The invention consists of the discovery that the incorporation of non-conductive fibres with a length comprised between 0.05 and 1 mm into the active material, in a quantity ranging from 0.6 to 1.5% of the weight of the paste, allows a reduction in the quantity of binder without this reduction being detrimental to the mechanical performance of the active material and to its adhesion to the current conducting support.

The invention includes an alkaline electrolyte battery comprising such an electrode.

### DETAILED DESCRIPTION OF THE EMBODIMENTS OF THE INVENTION

According to a preferred embodiment of the invention, the electrode is of the non-sintered type, i.e pasted or plastic-bonded.

The positive active material can be any positive active material known in the art for alkaline batteries. For example, an active material comprising an hydroxide based on nickel or an active material comprising a manganese hydroxide may be mentioned. The embodiments described in the following make reference to an active material essentially comprising an hydroxide based on nickel without limitation of this hydroxide.

By “hydroxide based on nickel” is meant nickel hydroxide Ni(OH)₂, a hydroxide principally containing nickel, but also a nickel hydroxide containing at least one syncrystallized hydroxide of an element chosen from zinc (Zn), cadmium (Cd), magnesium (Mg) and aluminium (Al), and at least one syncrystallized hydroxide of an element chosen from cobalt (Co), manganese (Mn), aluminium (Al), yttrium (Y), calcium (Ca), strontium (Sr), zirconium (Zr), copper (Cu). The active material can also be covered with a coating based on a cobalt compound such as cobalt oxide or hydroxide, a mixed oxide of lithium and cobalt LiCoO₂ or a conductive cobalt oxide with a valency higher than 2 optionally containing other elements such as nickel, zinc, aluminium and/or manganese.

Nickel hydroxide is a poorly conductive compound which generally requires the addition of a conductive material allowing good electrical percolation to the paste. The nickel hydroxide particles are therefore preferably mixed with a conductive material comprising conductive particles.

The conductive particles can be chosen from particles of carbon, particles of metal, such as nickel for example, or the powder of a compound of a transition metal such as for example, Co, CoO, Co(OH)₂, the mixed oxide lithium and cobalt LiCoO₂ and a conductive cobalt oxide with a valency higher than 2.

Preferably, the conductive particles are essentially constituted by a cobalt compound, preferably metal cobalt Co, cobalt oxide CoO, cobalt hydroxide Co(OH)₂, the mixed oxide lithium and cobalt LiCoO₂ or a conductive cobalt oxide with a valency higher than 2.

Advantageously, the weight percentage of conductive material in the paste represents from 3% to 15% of the weight of the paste. Above this value, the capacity of the electrode reduces due to the proportional reduction of the quantity of active material.

The binder comprises at least one polymer chosen from an optionally carboxylated styrene-butadiene copolymer (SBR), an acrylonitrile-butadiene copolymer (NBR), a styrene-ethylene-butylene-styrene copolymer (SEBS), polytetrafluoroethylene (PTFE), a styrene-acrylate copolymer (PSA) which is a combination of styrene elementary units on the one hand and of acrylic or acrylate ester elementary units on the other hand, a styrene-maleic anhydride copolymer (SMA).

Advantageously, the weight percentage of the binder in the paste represents from 0.2% to 2.5% of the weight of the paste.

In order to facilitate production of the electrode, a thickening agent is used to obtain a satisfactory viscosity in the production process, in particular carboxymethyl cellulose (CMC), methyl cellulose (MC), methylhydroxyethyl cellulose (MHEC), methylhydroxypropyl cellulose (MHPC), hydroxyethyl cellulose (HEC), hydroxypropylmethyl cellulose (HPMC), hydroxypropyl cellulose (HPC), polyacrylic acid (PAAc), a vegetable thickening agent (xanthan gum, carrageenan, etc.)

Advantageously, the weight percentage of the thickening agent in the paste represents from 0.05% to 0.5% of the weight of the paste.

According to the invention, the paste comprises non-conductive fibres with a length comprised between 0.05 and 1 mm, and the weight percentage of which represents from 0.6 to 1.5% of the weight of the paste.

By “fibres” is meant particles in which one spatial dimension is larger than the other.

Let D be the mean transverse dimension and L the mean length of said fibres. Preferably L is greater than or equal to 10 times D; preferably also, L is greater than or equal to 25 times D.

Said fibres are non-current conducting fibres such as for example polyethylene, polyamide or polypropylene fibres.

Preferably the non-conductive fibres are polypropylene fibres.

The paste can also contain at least one compound chosen from compounds of zinc such as ZnO or Zn(OH)₂, of yttrium (Y) such as Y₂O₃ or Y(OH)₃, of ytterbium such as Yb₂O₃ or Yb(OH)₃, of calcium such as CaO, Ca(OH)₂, of erbium such as Er₂O₃, Er(OH)₃. This compound is usually added in powder form.

The paste is deposited on a current support which can be two-dimensional or three-dimensional.

The electrode according to the invention can be used in any alkaline electrolyte battery, such as for example batteries containing nickel-hydrogen-fixing metal, nickel-cadmium, nickel-iron, nickel-zinc, nickel-hydrogen couples.

The electrolyte is generally a concentrated alkaline aqueous solution comprising at least one hydroxide (KOH, NaOH, LiOH), at a concentration which is generally several times molar.

The non-woven separator is generally made of polyolefin, for example of polyethylene or polypropylene.

In a conventional manner, the pastes for electrodes are prepared, the electrodes are produced, then at least one positive electrode, a separator and a negative electrode are stacked on top of one another in order to constitute the electrochemical bundle. The electrochemical bundle is introduced into a small container and it is impregnated with an aqueous alkaline electrolyte. The battery is then closed in a sealed or a non-sealed manner.

The invention relates to any battery format: the prismatic format (flat electrodes) or cylindrical format (spiral or concentric electrodes).

The battery according to the invention is particularly well suited as an energy source for portable applications, electric and hybrid vehicles, space applications, telecommunications and safety lighting applications.

Other characteristics and advantages of the present invention will become apparent on reading the examples.

### EXAMPLES

### Example 1

The plasticized type positive electrode A of the prior art is produced with the following composition by weight:

| | |
|---|---|
| electrochemically-active material | 90.7% |
| conductive material | 6% |
| binder | 3% |
| thickening agent | 0.3% |

The electrochemically-active material in powder form is constituted by an hydroxide based on nickel. The conductive material is cobalt hydroxide. The binder is polystyrene acrylate (PSA). The thickening agent is carboxymethyl cellulose (CMC). The viscosity of the paste is adjusted with water. The paste is deposited on a two-dimensional support serving as a current collector which is a nickel plated steel strip. The electrode is dried in order to remove the water from it, then laminated.

### Example 2

The plasticized type positive electrode B of the prior art is produced in the same way as for Example 1 with the following composition by weight:

| | |
|---|---|
| electrochemically-active material | 93% |
| conductive material | 6% |
| binder | 0.7% |
| thickening agent | 0.3% |

The components are identical to those of Example 1.

### Example 3

The plasticized type positive electrode C according to the invention is produced in the same way as for Example 1 with the following composition by weight:

| | |
|---|---|
| electrochemically-active material | 92.4% |
| conductive material | 6% |
| binder | 0.7% |
| thickening agent | 0.3% |
| fibres | 0.6% |

The fibres are polypropylene fibres with a length of 0.5 mm and a diameter of 20 μm. The other components of the electrode are unchanged. The electrode is then laminated to the same thickness as that of the electrode of Example 1.

### Example 4

The plasticized type positive electrode D which is outside the field of the invention is produced in the same way as for Example 1 with the following composition by weight:

| | |
|---|---|
| electrochemically-active material | 91% |
| conductive material | 6% |
| binder | 0.7% |
| thickening agent | 0.3% |
| fibres | 2% |

The fibres used are identical to those of Example 3.

### Example 5

The plasticized type positive electrode E which is outside the field of the invention is produced with the following composition by weight:

| | |
|---|---|
| electrochemically-active material | 92.9% |
| conductive material | 6% |
| binder | 0.7% |
| thickening agent | 0.3% |
| fibres | 0.1% |

The fibres used are identical to those of Example 3.

### Example 6

The plasticized type positive electrode F which is outside the field of the invention is produced in the same way as for Example 1 with the following composition by weight:

| | |
|---|---|
| electrochemically-active material | 90.7% |
| conductive material | 6% |
| binder | 2.9% |
| thickening agent | 0.3% |
| fibres | 0.1% |

The fibres used are identical to those of Example 3.

A test of the mechanical performance of the positive electrodes is carried out under the following conditions.

The electrode is weighed initially, then dropped without initial speed from a height of 50 cm onto a hard, flat surface. The drop is repeated 10 times. The electrode is then weighed again and the mass loss as a percentage relative to the initially weighed mass represents the mechanical performance of the material on the two-dimensional support.

The results are shown in Table 1.

TABLE 1

| | Electrode | | | | | |
|---|---|---|---|---|---|---|
| | A | B | C | D | E | F |
| Mass loss (%) | 0.7 | 4 | 0.4 | 0.3 | 3.8 | 0.65 |
| Percentage of fibres | — | — | 0.6 | 2 | 0.1 | 0.1 |
| Percentage (binder + fibres) | 3 | 0.7 | 1.3 | 2.7 | 0.8 | 3 |

A mass loss of around 0.5% in this test can be considered as satisfactory.

Electrode A of the prior art has a satisfactory mass loss but a high quantity of binder, equal to 3%.

Electrode C according to the invention has an excellent mechanical performance, better than that of electrode A, for a weight percentage (binder+fibres) of 1.3%, therefore lower than 3 performance %.

Electrode B of the prior art comprising a percentage of binder equal to that of the invention but no fibres does not have a satisfactory mechanical performance.

Electrode E which is outside the field of the invention does not have satisfactory mechanical performance because of the insufficient quantity of fibres with a small percentage of binder.

In order to obtain a satisfactory mechanical performance, with a plasticized type electrode and a percentage of fibres of 0.1%, it is necessary to have a percentage of binder of 2.9%, as observed for the F series.

Sealed nickel-hydrogen fixing metal (Ni-MH) AA-size batteries, the desired capacity C of which is 1200 mAh, are produced using electrodes A to F.

The negative electrode has an intermetallic compound capable of forming a hydride once it is charged as electrochemically-active material.

Its capacity is greater than that of the positive electrode.

Each positive electrode is placed alongside a negative electrode from which it is isolated by a separator constituted by a polypropylene non-woven fabric in order to form the electrochemical bundle. The bundle is spirally wound, inserted into a small metal container and impregnated with an alkaline electrolyte which is an aqueous alkaline solution constituted by a mixture of 7.4 N potassium hydroxide KOH, 0.5 N lithium hydroxide LiOH and 0.4 N sodium hydroxide NaOH. Six series A to F of ten batteries comprising the same positive electrode are produced.

After 48 hours rest at ambient temperature, an electrical forming of the batteries is carried out under the following conditions.

Cycle 1:
rest 2 hours at 75° C.;
charge at 0.1 Ic for 4 hours at 75° C.,

where Ic is the current necessary for discharging the nominal capacity C of the battery in 1 hour;
rest 2 hours at 20° C.;
charge 3 h at 0.33 Ic;
discharge at 0.2 Ic to a voltage of 0.9V;

Cycle 2:
charge 16 hours at 0.1 Ic;
discharge at 0.21 Ic to a voltage of 0.9V.

The capacities of the batteries in cycle 2 are shown in Table 2 below.

TABLE 2

| | Battery series | | | | | |
|---|---|---|---|---|---|---|
| | A | B | C | D | E | F |
| Capacity in cycle 2(mAh) | 1220 | — | 1340 | 530 | — | 1210 |

As regards series D, the presence of fibres in a large quantity inside the electrode does not allow a correct spiral mounting of the electrodes. The D-type plasticized positive electrodes, despite having a satisfactory mass loss in the test described previously, are too rigid and breakable and all of the batteries obtained with these electrodes either short circuit or their performance is mediocre.

The batteries of series C allow an increase in capacity of 10% compared to the batteries of series A. It is thus possible to produce batteries with high volume energy with the plasticized type electrodes of the invention.

Of course, the present invention is not limited to the embodiment described but numerous variations accessible to a person skilled in the art can be applied without exceeding the scope of the invention.

1. Positive electrode for an alkaline electrolyte battery comprising a conductive support covered with a paste comprising:
an electrochemically-active material,
a binder and
non-conductive fibres with a length comprised between 0.05 and 1 mm, the weight percentage of the fibres representing from 0.6 to 1.5% of the weight of said paste.

2. Electrode according to claim 1, in which the fibres are chosen from the group comprising polyethylene fibres, polyamide fibres and polypropylene fibres.

3. Electrode according to claim 2, in which the fibres are polypropylene fibres.

4. Electrode according to claim 1, in which the weight percentage of binder represents from 0.2% to 2.5% of the weight of the paste.

5. Electrode according to claim 1, in which the paste also comprises a thickening agent.

6. Electrode according to claim 5, in which the weight percentage of thickening agent represents from 0.05% to 0.5% of the weight of the paste.

7. Electrode according to claim 1, in which the paste also comprises a conductive material.

8. Electrode according to claim 7, in which the weight percentage of the conductive material represents from 3 to 15% of the weight of said paste.

9. Electrode according to claim 1, in which the conductive support is two-dimensional.

10. Electrode according to claim 1, in which the electrochemically-active material is an hydroxide of nickel.

11. Electrode according to claim 1, in which the electrode is non-sintered.

12. Alkaline electrolyte battery comprising an electrode according to claim 1.
